(19) United States
(12) Patent Application Publication
(10) Pub. No.: US 2021/0115526 A1
(43) Pub. Date: Apr. 22, 2021

(54) ELECTROPULSING METHODS FOR ADDITIVELY MANUFACTURED MATERIALS

(71) Applicant: National Technology & Engineering Solutions of Sandia, LLC, Albuquerque, NM (US)

(72) Inventors: Philip Noell, Albuquerque, NM (US); Jeffrey Rodelas, Albuquerque, NM (US); Zahra Ghanbari, Albuquerque, NM (US)

(21) Appl. No.: 17/061,362

(22) Filed: Oct. 1, 2020

Related U.S. Application Data
(60) Provisional application No. 62/916,597, filed on Oct. 17, 2019.

(51) Int. Cl. C21D 1/04; C22F 1/04; C21D 1/34

(52) U.S. Cl. CPC C21D 1/04; B33Y 40/20; C21D 1/34; C22F 1/04

(57) ABSTRACT

The present invention relates to treating a test sample using electropulsing. In particular, the test sample includes an additively manufactured material. Such electropulsing can provide enhanced properties, such as modified material properties such as improved ductility.

### CROSS-REFERENCE TO RELATED APPLICATION

This application claims the benefit of U.S. Provisional Application No. 62/916,597, filed Oct. 17, 2019, which is incorporated herein by reference.

### STATEMENT OF GOVERNMENT INTEREST

This invention was made with Government support under Contract No. DE-NA0003 525 awarded by the United States Department of Energy/National Nuclear Security Administration. The Government has certain rights in the invention.

### FIELD OF THE INVENTION

The present invention relates to treating a test sample using electropulsing. In particular, the test sample includes an additively manufactured material. Such electropulsing can provide enhanced properties, such as modified material properties such as improved ductility.

### BACKGROUND OF THE INVENTION

Additive manufacturing (AM) is a promising, rapid-prototyping process. Yet, materials formed by AM generally require additional post-processing, such as annealing for long periods of time. Thus, there is a need for additional methodologies that can be employed to rapidly modify prototyped structures.

### SUMMARY OF THE INVENTION

The present invention relates to an electropulsing method to modify the material characteristics of structures formed by AM. In some embodiments, applying an electrical pulse of sufficient current density to the AM material provided reduced microsegregation of one or more chemical elements, as compared to the material without application of the electrical pulse.

In a first aspect, the present invention features a method including: providing a test sample including an additively manufactured material; and delivering an electrical pulse to the test sample. In some embodiments, the method provides a treated material having reduced microsegregration of one or more elements (e.g., iron, silicon, etc.), as compared to the test sample.

In some embodiments, the delivering step includes delivering a plurality of electrical pulses. In other embodiments, the plurality of pulses is of from about 5 to about 200 pulses (e.g., about 5 to 10 pulses, 5 to 20 pulses, 5 to 30 pulses, 5 to 40 pulses, 5 to 50 pulses, 5 to 60 pulses, 5 to 70 pulses, 5 to 80 pulses, 5 to 90 pulses, 5 to 100 pulses, 5 to 150 pulses, 10 to 20 pulses, 10 to 30 pulses, 10 to 40 pulses, 10 to 50 pulses, 10 to 60 pulses, 10 to 70 pulses, 10 to 80 pulses, 10 to 90 pulses, 10 to 100 pulses, 10 to 150 pulses, 10 to 200 pulses, 15 to 20 pulses, 15 to 30 pulses, 15 to 40 pulses, 15 to 50 pulses, 15 to 60 pulses, 15 to 70 pulses, 15 to 80 pulses, 15 to 90 pulses, 15 to 100 pulses, 15 to 150 pulses, 15 to 200 pulses, 20 to 30 pulses, 20 to 40 pulses, 20 to 50 pulses, 20 to 60 pulses, 20 to 70 pulses, 20 to 80 pulses, 20 to 90 pulses, 20 to 100 pulses, 20 to 150 pulses, 20 to 200 pulses, 25 to 30 pulses, 25 to 40 pulses, 25 to 50 pulses, 25 to 60 pulses, 25 to 70 pulses, 25 to 80 pulses, 25 to 90 pulses, 25 to 100 pulses, 25 to 150 pulses, 25 to 200 pulses, 30 to 40 pulses, 30 to 50 pulses, 30 to 60 pulses, 30 to 70 pulses, 30 to 80 pulses, 30 to 90 pulses, 30 to 100 pulses, 30 to 150 pulses, 30 to 200 pulses, 35 to 40 pulses, 35 to 50 pulses, 35 to 60 pulses, 35 to 70 pulses, 35 to 80 pulses, 35 to 90 pulses, 35 to 100 pulses, 35 to 150 pulses, 35 to 200 pulses, 40 to 50 pulses, 40 to 60 pulses, 40 to 70 pulses, 40 to 80 pulses, 40 to 90 pulses, 40 to 100 pulses, 40 to 150 pulses, 40 to 200 pulses, 45 to 50 pulses, 45 to 60 pulses, 45 to 70 pulses, 45 to 80 pulses, 45 to 90 pulses, 45 to 100 pulses, 45 to 150 pulses, 45 to 200 pulses, 50 to 60 pulses, 50 to 70 pulses, 50 to 80 pulses, 50 to 90 pulses, 50 to 100 pulses, 50 to 150 pulses, 50 to 200 pulses, 75 to 80 pulses, 75 to 90 pulses, 75 to 100 pulses, 75 to 150 pulses, 75 to 200 pulses, 100 to 150 pulses, or 100 to 200 pulses).

In some embodiments, the plurality of electrical pulses is repeated every about 1 second to about 20 seconds (e.g., about every 1 second to 5 seconds, 1 second to 10 seconds, 1 second to 15 seconds, 2 seconds to 5 seconds, 2 seconds to 10 seconds, 2 seconds to 15 seconds, 2 seconds to 20 seconds, 5 seconds to 10 seconds, 5 seconds to 15 seconds, 5 seconds to 20 seconds, 10 seconds to 15 seconds, or 10 seconds to 20 seconds).

In a second aspect, the present invention features a method including: providing a test sample comprising an additively manufactured material; and delivering a plurality of electrical pulses to the test sample. In some embodiments, the method thereby provides a treated material having reduced microsegregration of one or more elements, as compared to the test sample.

In any embodiment herein, the test sample includes aluminum and/or iron. In any embodiment herein, the electrical pulse increases a temperature of the test sample to from about 300° C. to about 1000° C. (e.g., from about 300° C. to 500° C., 300° C. to 600° C., 300° C. to 700° C., 300° C. to 800° C., 300° C. to 900° C., 300° C. to 1000° C., 400° C. to 500° C., 400° C. to 600° C., 400° C. to 700° C., 400° C. to 800° C., 400° C. to 900° C., 400° C. to 1000° C., 500° C. to 600° C., 500° C. to 700° C., 500° C. to 800° C., 500° C. to 900° C., 500° C. to 1000° C., 600° C. to 700° C., 600° C. to 800° C., 600° C. to 900° C., 600° C. to 1000° C., 700° C. to 800° C., 700° C. to 900° C., 700° C. to 1000° C., 800° C. to 900° C., 800° C. to 1000° C., or 900° C. to 1000° C.).

In any embodiment herein, the electrical pulse includes an alternating current. In some embodiments, the alternating current has a frequency of from about 10 Hz to about 100 Hz (e.g., about 10 Hz to 20 Hz, 10 Hz to 30 Hz, 10 Hz to 40 Hz, 10 Hz to 50 Hz, 10 Hz to 60 Hz, 10 Hz to 70 Hz, 10 Hz to 80 Hz, 10 Hz to 90 Hz, 20 Hz to 30 Hz, 20 Hz to 40 Hz, 20 Hz to 50 Hz, 20 Hz to 60 Hz, 20 Hz to 70 Hz, 20 Hz to 80 Hz, 20 Hz to 90 Hz, 20 Hz to 100 Hz, 40 Hz to 50 Hz, 40 Hz to 60 Hz, 40 Hz to 70 Hz, 40 Hz to 80 Hz, 40 Hz to 90 Hz, 40 Hz to 100 Hz, 60 Hz to 70 Hz, 60 Hz to 80 Hz, 60 Hz to 90 Hz, 60 Hz to 100 Hz, or 80 Hz to 100 Hz).

In any embodiment herein, a duration of the electrical pulse is of from about 2 milliseconds (ms) to about 30 ms (e.g., from about 2 ms to 8 ms, 2 ms to 10 ms, 2 ms to 12 ms, 2 ms to 14 ms, 2 ms to 16 ms, 2 ms to 18 ms, 2 ms to 20 ms, 2 ms to 22 ms, 2 ms to 24 ms, 2 ms to 26 ms, 2 ms to 28 ms, 5 ms to 8 ms, 5 ms to 10 ms, 5 ms to 12 ms, 5 ms to 14 ms, 5 ms to 16 ms, 5 ms to 18 ms, 5 ms to 20 ms, 5 ms to 22 ms, 5 ms to 24 ms, 5 ms to 26 ms, 5 ms to 28 ms, 5 ms to 30 ms, 10 ms to 12 ms, 10 ms to 14 ms, 10 ms to 16 ms, 10 ms to 18 ms, 10 ms to 20 ms, 10 ms to 22 ms, 10 ms to 24 ms, 10 ms to 26 ms, 10 ms to 28 ms, 10 ms to 30 ms, 15 ms to 18 ms, 15 ms to 20 ms, 15 ms to 22 ms, 15 ms to 24 ms, 15 ms to 26 ms, 15 ms to 28 ms, 15 ms to 30 ms, 20 ms to 22 ms, 20 ms to 24 ms, 20 ms to 26 ms, 20 ms to 28 ms, 20 ms to 30 ms, or 25 ms to 30 ms).

In any embodiment, a duration of the plurality of electrical pulses is of from about 10 s (seconds) to about 2000 s (e.g., from about 10 s to 100 s, 10 s to 250 s, 10 s to 500 s, 10 s to 750 s, 10 s to 1000 s, 10 s to 1250 s, 10 s to 1500 s, 10 s to 1750 s, 25 s to 100 s, 25 s to 250 s, 25 s to 500 s, 25 s to 750 s, 25 s to 1000 s, 25 s to 1250 s, 25 s to 1500 s, 25 s to 1750 s, 25 s to 2000 s, 50 s to 100 s, 50 s to 250 s, 50 s to 500 s, 50 s to 750 s, 50 s to 1000 s, 50 s to 1250 s, 50 s to 1500 s, 50 s to 1750 s, 50 s to 2000 s, 75 s to 100 s, 75 s to 250 s, 75 s to 500 s, 75 s to 750 s, 75 s to 1000 s, 75 s to 1250 s, 75 s to 1500 s, 75 s to 1750 s, 75 s to 2000 s, 100 s to 250 s, 100 s to 500 s, 100 s to 750 s, 100 s to 1000 s, 100 s to 1250 s, 100 s to 1500 s, 100 s to 1750 s, 100 s to 2000 s, 200 s to 250 s, 200 s to 500 s, 200 s to 750 s, 200 s to 1000 s, 200 s to 1250 s, 200 s to 1500 s, 200 s to 1750 s, 200 s to 2000 s, 400 s to 500 s, 400 s to 750 s, 400 s to 1000 s, 400 s to 1250 s, 400 s to 1500 s, 400 s to 1750 s, 400 s to 2000 s, 600 s to 750 s, 600 s to 1000 s, 600 s to 1250 s, 600 s to 1500 s, 600 s to 1750 s, 600 s to 2000 s, 800 s to 1000 s, 800 s to 1250 s, 800 s to 1500 s, 800 s to 1750 s, 800 s to 2000 s, 1000 s to 1500 s, or 1000 s to 2000 s).

In any embodiment herein, the electrical pulse includes a direct current. In some embodiment, the duration of the electrical pulse is of from about 10 ms to about 5 s (e.g., from about 10 ms to 50 ms, 10 ms to 100 ms, 10 ms to 500 ms, 10 ms to 1 s, 10 ms to 2 s, 10 ms to 3 s, 10 ms to 4 s, 25 ms to 50 ms, 25 ms to 100 ms, 25 ms to 500 ms, 25 ms to 1 s, 25 ms to 2 s, 25 ms to 3 s, 25 ms to 4 s, 25 ms to 5 s, 50 ms to 100 ms, 50 ms to 500 ms, 50 ms to 1 s, 50 ms to 2 s, 50 ms to 3 s, 50 ms to 4 s, 50 ms to 5 s, 75 ms to 100 ms, 75 ms to 500 ms, 75 ms to 1 s, 75 ms to 2 s, 75 ms to 3 s, 75 ms to 4 s, 75 ms to 5 s, 100 ms to 500 ms, 100 ms to 1 s, 100 ms to 2 s, 100 ms to 3 s, 100 ms to 4 s, 100 ms to 5 s, 500 ms to 1 s, 500 ms to 2 s, 500 ms to 3 s, 500 ms to 4 s, 500 ms to 5 s, 750 ms to 1 s, 750 ms to 2 s, 750 ms to 3 s, 750 ms to 4 s, 750 ms to 5 s, 1 s to 2 s, 1 s to 3 s, 1 s to 4 s, 1 s to 5 s, 2 s to 3 s, 2 s to 4 s, 2 s to 5 s, 3 s to 4 s, 3 s to 5 s, or 4 s to 5 s). In any embodiment herein, the electrical pulse provides a current density of from about 0.05 kA/mm² to about 10 kA/mm² (e.g., from about 0.05 kA/mm² to 1 kA/mm², 0.05 kA/mm² to 2 kA/mm², 0.05 kA/mm² to 4 kA/mm², 0.05 kA/mm² to 6 kA/mm², 0.05 kA/mm² to 8 kA/mm², 0.1 kA/mm² to 1 kA/mm², 0.1 kA/mm² to 2 kA/mm², 0.1 kA/mm² to 4 kA/mm², 0.1 kA/mm² to 6 kA/mm², 0.1 kA/mm² to 8 kA/mm², 0.1 kA/mm² to 10 kA/mm², 0.5 kA/mm² to 1 kA/mm², 0.5 kA/mm² to 2 kA/mm², 0.5 kA/mm² to 4 kA/mm², 0.5 kA/mm² to 6 kA/mm², 0.5 kA/mm² to 8 kA/mm², 0.5 kA/mm² to 10 kA/mm², 1 kA/mm² to 2 kA/mm², 1 kA/mm² to 4 kA/mm², 1 kA/mm² to 6 kA/mm², 1 kA/mm² to 8 kA/mm², 1 kA/mm² to 10 kA/mm², 2 kA/mm² to 4 kA/mm², 2 kA/mm² to 6 kA/mm², 2 kA/mm² to 8 kA/mm², 2 kA/mm² to 10 kA/mm², 5 kA/mm² to 8 kA/mm², or 5 kA/mm² to 10 kA/mm²).

In any embodiment herein, the electrical pulse provides a maximum current of from about 2 kA to about 30 kA (e.g., from about 2 kA to 10 kA, 2 kA to 15 kA, 2 kA to 20 kA, 2 kA to 25 kA, 3 kA to 10 kA, 3 kA to 15 kA, 3 kA to 20 kA, 3 kA to 25 kA, 3 kA to 30 kA, 4 kA to 10 kA, 4 kA to 15 kA, 4 kA to 20 kA, 4 kA to 25 kA, 4 kA to 30 kA, 5 kA to 10 kA, 5 kA to 15 kA, 5 kA to 20 kA, 5 kA to 25 kA, 5 kA to 30 kA, 8 kA to 10 kA, 8 kA to 15 kA, 8 kA to 20 kA, 8 kA to 25 kA, 8 kA to 30 kA, 10 kA to 15 kA, 10 kA to 20 kA, 10 kA to 25 kA, 10 kA to 30 kA, 12 kA to 15 kA, 12 kA to 20 kA, 12 kA to 25 kA, 12 kA to 30 kA, 14 kA to 20 kA, 14 kA to 25 kA, 14 kA to 30 kA, 16 kA to 20 kA, 16 kA to 25 kA, 16 kA to 30 kA, 18 kA to 20 kA, 18 kA to 25 kA, 18 kA to 30 kA, 20 kA to 25 kA, 20 kA to 30 kA, or 24 kA to 30 kA).

Definitions

As used herein, the term “about” means +/−10% of any recited value. As used herein, this term modifies any recited value, range of values, or endpoints of one or more ranges.

By “micro” is meant having at least one dimension that is less than 1 mm and, optionally, equal to or larger than about 1 μm. For instance, a microstructure (e.g., any structure described herein) can have a length, width, height, cross-sectional dimension, circumference, radius (e.g., external or internal radius), or diameter that is less than 1 mm.

By “nano” is meant having at least one dimension that is less than 1 μm but equal to or larger than about 1 nm. For instance, a nanostructure (e.g., any structure described herein, such as a nanoparticle) can have a length, width, height, cross-sectional dimension, circumference, radius (e.g., external or internal radius), or diameter that is less than 1 μm but equal to or larger than 1 nm. In other instances, the nanostructure has a dimension that is of from about 1 nm to about 1 μm.

As used herein, the terms “top,” “bottom,” “upper,” “lower,” “above,” and “below” are used to provide a relative relationship between structures. The use of these terms does not indicate or require that a particular structure must be located at a particular location in the apparatus.

Other features and advantages of the invention will be apparent from the following description and the claims.

### BRIEF DESCRIPTION OF THE DRAWINGS

FIG. 1 shows an optical image of a stainless steel tensile specimen used in this study is shown. The gauge and grip regions are labelled. The primary specimen directions are labelled as follows: tensile direction (TD), long transverse direction (LTD), and short transverse direction (STD).

FIG. 2A-2B shows the power angle for (A) the first pulse and (B) the fourth pulse (black lines) for sample 316 Epulse02. Sample temperature (gray lines) for these two pulses are also plotted.

FIG. 3A-3B shows graphs of sample temperature versus time for sample 316_Epulse02 for (A) all 10 cycles and (B) a single pulse.

FIG. 4 shows representative optical images of a 316 SS specimen that was electropulsed 10 times with a maximum current of 5 kA are shown. Both the specimen grip and gauge, as well as the transition between the two, can be seen in (a). High-magnification images of both the grip and gauge are provided in (b) to (d).

FIG. 5 shows EB SD data from the grip region of a 316 SS specimen that was electropulsed 10 times with a maximum current of 5 kA are plotted as IPF maps colored with respect to the (a) tensile direction (TD) and (b) short transverse direction (STD). Optical images in FIG. 4 show that the microstructure in the grip region of this specimen was not significantly altered by electropulsing.

FIG. 6 shows EB SD data from the gauge region of a 316 SS specimen that was electropulsed 10 times with a maximum current of 5 kA are plotted as IPF maps colored with respect to the (a) tensile direction (TD) and (b) short transverse direction (STD). Optical images in FIG. 4 show that electropulsing altered chemical microsegregation in the gauge region of this sample.

FIG. 7 shows EB SD data from the (a) grip and (b) gauge regions of a 316 SS specimen that was electropulsed 10 times with a maximum current of 5 kA are plotted as kernel average misorientation (KAM) maps.

FIG. 8A-8B shows the power angle for (A) the first pulse and (B) the second pulse (black lines) for sample AlEpluse-03. Sample temperature (gray lines) for these two pulses are also plotted.

FIG. 9A-9B shows graphs of sample temperature versus time for sample AlEpluse-03 for (A) the first five cycles and (B) two seconds after the second electrical pulse was applied to this sample.

FIG. 10 shows a graph of sample temperature versus time for sample AlEpluse-04 for the first five pulses applied to the sample.

FIG. 11 shows plots of engineering stress versus engineering strain for four AlSi10Mg samples.

FIG. 12 shows an optical image of specimen AlEpulse-06 after electropulsing. This sample was polished and etched.

FIG. 13 shows electron channeling contrast images of sample AlEpulse-06 after etching is provided. A low-magnification image of this specimen is shown in FIG. 12. Provided are images of (a) the grip region and (b) the gauge. Clear differences in the morphology of the Si-rich phase can be seen.

FIG. 14 shows electron channeling contrast images of polished AlSi10Mg samples. The samples in (a) and (b) were in the as-received and heat-treated conditions, respectively. Samples in (c) to (f) were electropulsed. The average peak current density and number of pulses applied to each sample are listed. Si-rich platelets and/or particles appear as white in images of all specimens. All images are at the same scale.

FIG. 15 shows representative EDS data from an as-received AlSi10Mg sample.

FIG. 16 shows EDS data highlighting the distribution of Si in (a) as-received, (b) heat-treated, and (c) and (d) electropulsed AlSi10Mg samples.

FIG. 17 shows EBSD data from the as-received grip region of specimen AlEpulse-06, which are plotted as an IPF maps colored with respect to the (a) TD and (b) STD, (c) an image quality (band contrast) map, and a (d) KAM map. Black lines overlaid on the map in (a) highlight high-angle (>5°) grain boundaries.

FIG. 18 shows EB SD data from the electropulsed gauge region of specimen AlEpulse-06, which are plotted as an IPF maps colored with respect to the (a) TD and (b) STD, (c) an image quality (band contrast) map, and a (d) KAM map. Black lines overlaid on the map in (a) highlight high-angle (>5°) grain boundaries.

### DETAILED DESCRIPTION OF THE INVENTION

For many applications, the promises of additive manufacturing (AM) of rapid development cycles and fabrication of ready-to-use, geometrically-complex parts cannot be realized because of cumbersome thermal postprocessing. This postprocessing is necessary when the non-equilibrium microstructures produced by AM lead to poor material properties.

The present invention relates to use of electropulsing (e.g., a process of sending high-current-density electrical pulses through a metallic part) to modify the material properties of AM parts. This process has been used to modify conventional wrought materials but has never been applied to AM materials. For example and without limitation, two representative AM materials were examined: 316 L stainless steel and AlSi10Mg. Two hours of thermal annealing are needed to remove chemical microsegregation in AM 316 L; using electropulsing, this was accomplished in 200 seconds. The ductility of Al Si10Mg parts was increased above that of the as-built material using electropulsing. This study demonstrated that electropulsing can be used to modify the microstructures of AM metals. Additional details follow.

### EXAMPLES

### Example 1

### Microstructural Modification and Healing of Additively Manufactured Parts by Electropulsing

Additive manufacturing (AM) is a rapid, flexible technique for manufacturing complex metallic components. Selective laser melting (SLM), also called laser powder bed fusion or direct metal laser sintering, is an AM technique which uses a laser to selectively melt a bed of metal powder. Each layer of melted metal is deposited on the previous layer, allowing the fabrication of near-net-shape parts. Because the melted material in each layer is rapidly cooled by the surrounding powder, as-built SLM parts are far from equilibrium. Microstructural features such as non-equiaxed grains, strong textures, significant residual density of dislocations, and chemical segregation are thus typical of as-built SLM parts. These features can lead to high hardness and strength but are also often associated with lowered ductility and corrosion resistance compared to conventional wrought materials [1-5].

At present, post-build heat treatments are commonly employed to decrease chemical microsegregation, reduce residual stresses, and/or produce equiaxed grains with random textures [2, 4]. There are, of course, significant downsides to adding an additional processing step to SLM parts such as decreased part throughput and increased lead time. Heat treatment is occasionally unfeasible due to part warpage during high-temperature exposure. Moreover, a recent study of 304L stainless steel fabricated by directed energy deposition, an AM technique that produces microstructures similar to SLM, demonstrated that significantly higher temperatures and longer exposure times were necessary to remove chemical microsegregation and cause recrystallization than in a comparable wrought material [6]. Similar observations have been reported for SLM 316 L [7]. The present study thus examines an alternative method for postprocessing SLM, and by extension all metallic AM materials: electropulsing.

Electropulsing is defined as the passage of electrical current through a material [8]. This can be done both by application of a continuous current and multiple high-current density pulses of short duration, typically in the form of controlled electrical pulses. Since the pioneering work of Troitskii in the 1960's [9-10], this technique has been applied to many materials, including copper [11], steels [12-13], and aluminum alloys [14-15]. Many effects have been observed, including: accelerated recrystallization [11, 14, 16-17]; crystallization of amorphous alloys [18-19]; crack closure [16]; and accelerated phase transformations [20-21].

Historically, most studies of electropulsing focused on the capacity of electropulsing to produce recrystallization much more rapidly and with significantly less heat input that traditional heat treating [11, 14, 16-17]. Similarly, studies of amorphous materials demonstrated that electropulsing can lead to partial or complete crystallization of the microstructure, depending on the current density and number of pulses alloys [18-19]. Electropulsing has also been observed to partially or completely close cracks and pores in materials, particularly at relatively low current densities (I≈10⁻¹ kA/mm²) [22].

More recently, several studies have demonstrated that electropulsing can influence the precipitation and aging of second-phase particles and intermetallic compounds. In their study of a Cu—Zn alloy with lead inclusions, Wang et al. observed that electropulsing formed many, small lead particles segregated to grain boundaries rather than the few, large lead particles consistently observed following various heat treatments [23]. Electropulsing of pearlitic steels has been observed to lead to fragmentation of the lamellar structure the formation of nanoscale γ-Fe particles [24-25]. In stainless steels, Qin and coworkers observed that electropulsing 316 stainless steel (SS) during annealing reduced the average size of ₜ-phase particles by a factor of 5 [26].

However, compared to conventional diffusion-controlled heat treatment processes, there is little understanding of the mechanisms that control microstructural evolution during electropulsing. Broadly speaking, three mechanism have been proposed: Joule heating, electron wind, and altering the activation energy [8, 13, 15, 20]. Joule heating is the process by which passing an electric current through a conductor produces heat. While Joule heating may play a role in electropulsing at all current densities, it appears to dominate at current densities below ≈100 kA/mm² [27-29].

At current densities greater than ≈100 kA/mm², the effects of electropulsing cannot be explained by Joule heating alone [8, 13]. It is thus thought that electropulsing induces changes in the microstructure by some combination of electron wind effects and by altering the activation energy of the material. The term electron wind refers to the force caused by the exchange of momentum between ionized atoms and other charge carriers in a material when current is passed [30-31]. This phenomenon has long been studied in the field of electromigration [31]. The importance of electron wind to electropulsing is, however, unclear. It is commonly used to explain electropulsing-induced recrystallization because the electron wind force may be capable of enhancing the mobility of dislocations [21, 32-33]. It is also thought that the additional free energy associated with applying an electric current, ΔG^{e}, plays a key role in electropulsing at currents greater than ≈100 kA/mm² [8, 13].

Decoupling the effects of these various mechanisms remains challenging, though. Because of this, the combination of electrical current density, pulse duration, and exposure time are empirically determined for each material. Moreover, it is usually unknown a priori what microstructural changes to expect when a given material is subjected to electropulsing [34]. Prior studies have primarily examined wrought sheet materials, and desirable microstructural changes were only attained in some cases. Moreover, compared to conventional wrought or cast materials, SLM materials are far from equilibrium and contain complex non-equilibrium chemical and dislocation substructures as well as complex non-equilibrium grain structures. It is thus unclear if and how electropulsing will affect the microstructure and properties of materials manufactured by SLM as such studies have never been conducted.

This study examines if electropulsing can be used to alter chemical segregation in additively manufactured materials. Two alloy systems were selected for this study: 316 L stainless steel (316 L SS) and AlSi10Mg. These material systems were chosen both because of their widespread use and because of the significantly different microstructures produced when these materials are processed by SLM. 316 L SS is an austenitic stainless steel that offers improved corrosion resistance relative to 304 L, moderate strength via solid solution strengthening, and excellent ductility. The rapid solidification behavior of 316 L under non-equilibrium conditions such as metal additive manufacturing is largely similar to high-energy density welding as reported in detail in the technical literature [35-36]. Like 304 L, the solidification microstructure of AM 316 L depends largely on the starting alloy composition; however, most 316 L alloy compositions subject to SLM solidify as austenite with no terminal solidification products [37-39]. The solidification substructure exhibits elemental partitioning of principally ferrite-promoting alloying elements such as chromium, molybdenum, and silicon [40]. This microsegregation can lower the corrosion resistance of the material, as discussed by Trelewicz et al [1]. While austenitic stainless steel solidification microstructures are not typically heat treated after fabrication there have been a number of studies in the technical literature that show solutionizing annealing heat treatment can eliminate microsegregation, dislocation networks, and/or or promote recrystallization in microstructures produced via AM [6-7].

AlSi10Mg is a hypoeutectic aluminum-silicon-magnesium alloy that is an appealing candidate for SLC due to its light weight and low melting point [4, 41]. Another considerable advantage to AlSi10Mg is that it is a casting alloy with intrinsically good solidification behavior. As-fabricated AlSi10Mg materials typically exhibit a cellular/cellular-dendritic solidification substructure containing primary α-Al dendrites surrounded by α-Al+silicon terminal interdendritic eutectic constituent [2, 4]. After fabrication, this material is typically heat treated at 300° C. for 120 minutes, which results in eutectic Si particle coarsening and precipitation of Si in the primary α-Al phase [2, 4]. This heat treatment also significantly changes the mechanical properties of the material, decreasing the ultimate tensile strength (UTS) from approximately 380 MPa to 250 MPa and increasing the ductility from approximately 2% to 10 to 18% [3]. While less common, other heat treatment methods have been examined, including the T6 heat-treatment typically used for 6000-series Al alloys. This heat treatment involves a solution heat treatment for 1 hour at 520° C. followed by artificial ageing for approximately 6 hours at 160° C. [42]. The mechanical properties of AlSi10Mg materials after several different heat treatment methods are summarized in Table 1. The general effect of all these heat treatments is to alter the distribution of the Si-rich phase, as discussed in references [2,5].

TABLE 1
Effect of heat treatment (HT) on AlSi10Mg materials

| | Vickers | Ultimate tensile | Elongation | Ref- |
|---|---|---|---|---|
| Heat-treatment | hardness* | strength [MPa]* | [%]* | erence |
| 300° C., 2 hours | — | 285 (475) | 18.6 (7.5) | [2] |
| 530° C., 6 hours | — | 269 (475) | 18.3 (7.5) | [2] |
| 240° C., | 124 (128) | — | — | [5] |
| 0.25 hours | | | | |
| 282° C., | 108 (128) | — | — | [5] |
| 0.25 hours | | | | |
| 307° C., | 98 (128) | — | — | [5] |
| 0.25 hours | | | | |
| 450° C., | 58 (128) | — | — | [5] |
| 0.50 hours | | | | |
| T6 | — | 300 (350) | 2.5 (3) | [43] |
| T6 | — | 280 (320) | 4.5 (1.25) | [42] |

*For comparison, the as-fabricated (AF) properties of the material used in the study are
listed in parentheses after each value

In the present study, SLM 316 SS and AlSi10Mg materials were electropulsed using a Gleeble® 3800 using alternating current (AC) current (60 Hz) under atmospheric conditions. Direct current (DC) is typically used for electropulsing, but a previous study demonstrated that electropulsing can also be performed using AC [28]. AC was chosen for this study due to the availability of the Gleeble® to perform electropulsing; yet this work could be extended to examine the effect of using DC to electropulse SLM materials. The focus of this work was to understand of electropulsing could be used to (1) control chemical microsegregation in SLM 316 SS and (2) the distribution of second-phase particles in AlSi10Mg.

### Example 2

### Exemplary Materials and Methods

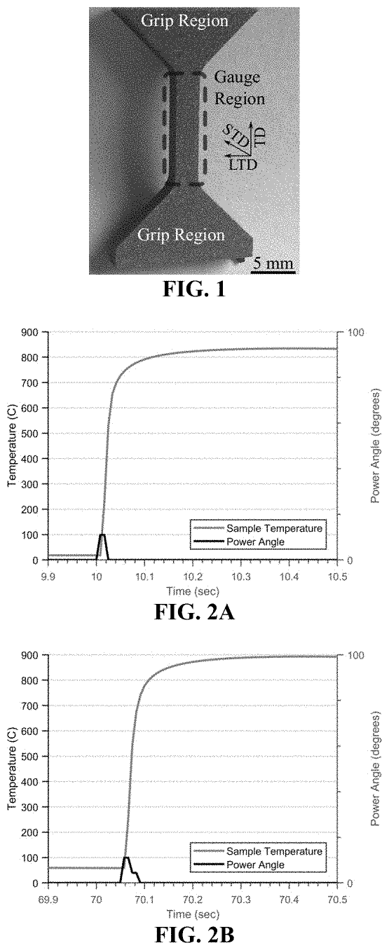

Two factors were considered when designing specimens. First, it was desirable to be able to grip specimens using the Gleeble® 3500 (Dynamic Systems Inc., Poestenkill, N.Y.) thermo-physical simulator (described in a subsequent paragraph). Second, it was desirable to be able to perform tensile tests on samples after electropulsing. Because of this, tensile dogbones, such as the one shown in FIG. 1, were utilized in this study. The specimens were of a uniform thickness of 2.5 mm. The gauge width was 2.5 mm and the gauge length was 10 mm, with a 45° fillet between the grip and gauge regions.

316 L SS samples were manufactured using AISI 316 L stainless steel powder (3D Systems, Rock Hill, S.C.) on a ProX DMP 200 PBF machine (3D systems). The build parameters include nominal laser power of 100 W, a nominal scan velocity of 1400 mm/s, nominal hatch spacing of 50 μm. Tensile specimens were built with the tensile axis parallel to the build direction. No post-build heat treatment was applied to these samples, which were removed from the build plate via electrical discharge machining (EDM).

AlSi10Mg samples were manufactured from commercial purity AlSi10Mg AM powder on an EOS (Krailling, Germany) M290 SLM printer. The build parameters included a laser power of 277.5 W, a scan velocity of 1300 mm/s, and the build had 5.0 mm stripe widths with 0.09 mm hatch spacing and 0.12 mm stripe section overlap. Tensile specimens were built with the tensile axis parallel to the build direction. The commonly performed stress-relief anneal thermal processing step was omitted in lieu of the electropulsing. Samples were removed from the build plate via wire EDM.

Electropulsing was performed using a Gleeble® 3500 (Dynamic Systems Inc., Poestenkill, N.Y.) thermo-physical simulator. The Gleeble® is conventionally used to replicate microstructures resulting from dynamic thermomechanical loading conditions (such as those encountered in welding or hot forming operations) that are otherwise very difficult or impossible using traditional furnace or mechanical tests. Thermocouple-instrumented samples in the Gleeble® are heated resistively using a 100 KVA single-phase AC transformer similar to that used for resistance welding. Thermocouples attached to the test sample interface with a closed-loop thermal control system that controls transformer output to affect the magnitude of heat generated resistively within the test sample. The Gleeble® thermal control system is able to precisely control dynamic heating rates as high as 10,000° C./sec. Additionally, force can be applied to the sample during heating/cooling via a closed-loop hydraulic servo mechanism.

The electropulse samples were held in the Gleeble® chamber using copper (Cu) grips and the load minimized such that minimal stress was imparted on the samples during loading and unloading. The electropulsing tests were performed in force-control-mode, meaning that the displacement between the jaws was adjusted to during the tests such that zero load was maintained on the sample to help accommodate for small changes in sample length due to thermal expansion/contraction.

Electropulsing was accomplished by operating the Gleeble® open loop in which the magnitude of current applied to the sample was controlled by tailoring the phase angle of AC power delivered by the transformer via a silicon-controlled rectifier (SCR). The phase angle is the proportion of the sinusoidal AC current waveform where the transformer is switched on using the SCR thereby allowing current to flow through the sample. The Gleeble® was programmed to deliver a current pulse with duration 16.67 ms (or one period of an AC cycle), followed by a 10 s natural cooling period (i.e. no output from the transformer with no external cooling applied). This natural cooling period was increased to 20 s for stainless steel materials to allow samples of this material to fully cool to room temperature. The power supply control incorporated a programmed loop to achieve the desired total number of pulses per test.

The amount of current delivered to the specimen during each pulse was varied by changing the SCR phase angle delivered to the specimen. The tap setting on the Gleeble® can also be adjusted to influence the voltage, therefore the tap setting was also increased during preliminary tests on stainless steel samples to in turn increase the current supplied to the specimen. All tests were conducted in an air with no protective atmosphere. Because the voltage and current delivered to the specimen are not variables directly monitored by the Gleeble®®, a Rogowsky coil with integral resistance weld process monitor (MM-112A, Amada Miyachi, Isehara City, Kanagawa, Japan) was placed around the Cu transformer output bus bar in the Gleeble®® such that the current flowing through the specimen could be monitored for each pulse. The peak current (in kiloamps, kA) was then reported for each pulse. The peak current readings and sample geometry were then used to calculate the current density through the sample for each pulse.

Specimens were tested in quasistatic, uniaxial tension at room temperature. Tensile tests were performed using displacement-control at a constant displacement rate of 0.2 mm/s using an MTS servo-hydraulic load frame. Strain measurements were performed real time using non-contact Digital Image Correlation (DIC). A commercial software, VIC-Gauge™, produced by Correlated Solutions Inc. (Columbia, S.C.), was used to measure strain in situ.

After tensile testing, specimens were ground and polished for microscopy. Stainless steel specimens were etched using 60 wt. % HNO₃ and 40 wt. % distilled water at room temperature for approximately 60 seconds using 10 mA/cm² of current. AlSi10Mg samples were etched using Keller's reagent [44]. Optical microscopy was performed using a Zeiss Axio Observer. Electron microscopy was performed using a Zeiss Supra 55VP field emission scanning electron microscope (SEM). Electron backscatter diffraction (EBSD) was performed in this microscope using Oxford HKL AZtec™ software. EBSD data were processed using MTEX [45], an extension for MATLAB™.

### Example 3

### Electropulsing 316 Stainless Steel

Two stainless steel specimens were electropulsed. Both were electropulsed with the same nominal settings, which produced a maximum current in the specimens of 5 kA. This corresponds to a current density of 0.81 kA/mm². These specimens will be referred to as 316_Epulse01 and 316_Epulse02. Five pulses were applied to 316_Epulse01 and ten pulses to 316_Epulse02. Plots of controller power angle for the first and fourth pulses applied to this sample are provided in FIG. 2A-2B.

For all but the fourth pulse, the controller fired a single pulse, while two pulses were applied to the sample during the fourth pulse. When a single pulse was applied to the sample, the maximum sample temperature was approximately 820° C. and the duration of the pulse was approximately 0.01 seconds. When two pulses were applied to the sample, the sample reached a temperature of 893° C. and the pulse lasted approximately 0.02 seconds. This only occurred during electropulsing of sample 316_Epulse02.

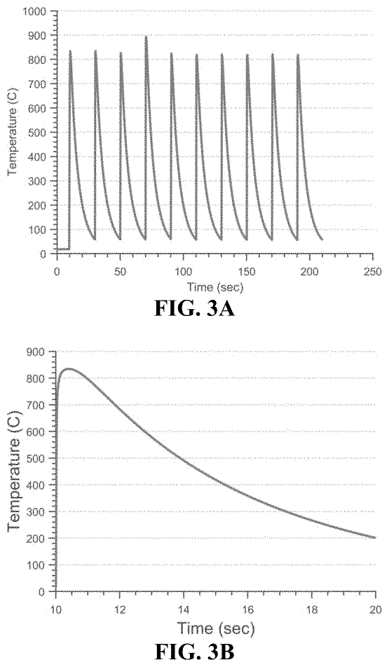

Representative temperature versus time data from 316_Epulse02 are provided in FIG. 3A-3B. When an electrical pulse was applied, the specimen reached its maximum temperature within approximately 0.2 seconds. Specimens remained over 800° C. for approximately 1 second, then cooled to room temperature within approximately 20 seconds.

After electropulsing, each specimen was ground flat, polished, and etched using the etching procedure described in the previous section. Vickers hardness was measured in the grip and gauge regions of both specimens. Values of 230±5 were measured in the grip and gauge regions of both specimens.

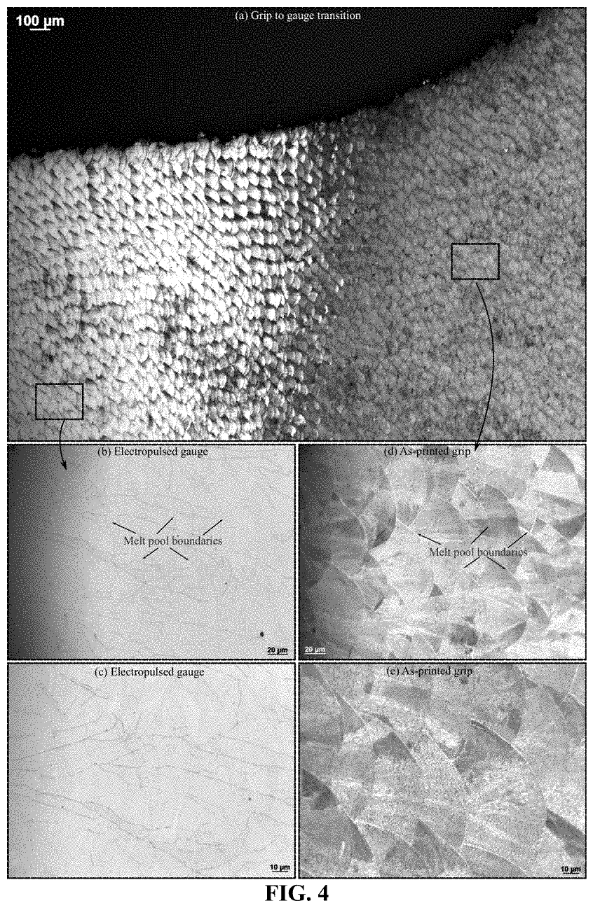

Optical images revealed significant differences between the grip and gauge regions of specimen 316_Epulse02. Optical images of the gauge and grip region of this sample are shown in FIG. 4. Melt pool boundaries can be observed both in the grip and gauge regions of the specimen. A few of these are labelled in FIG. 4. The etching response thus suggests that microsegregation associated with the melt pool boundary did not change appreciably.

In the grip portion of the sample, the etching response shows typical cellular structure associated with solidification substructure in rapidly solidified austenitic stainless steel [46]. This cellular structure is highlighted in FIG. 4. In the gauge region, these cell boundaries are not visible. These images indicate that the chemical segregation in the gauge is significantly lower than that in the grip. No significant differences were observed between the grip and gauge region of a specimen that was given only 5 pulses, specimen 316_Epulse01.

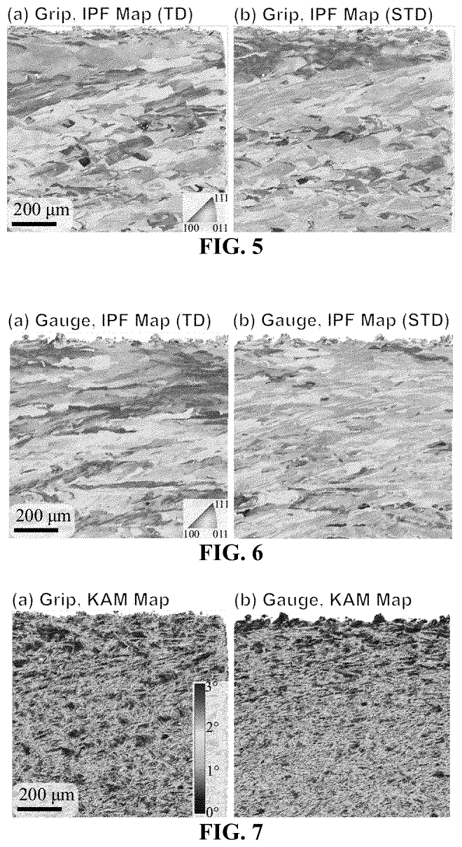

EBSD data were collected from the grip and gauge regions of specimen 316_Epulse02 using a 2 μm step-size. EBSD data from the grip region are plotted as inverse pole figure (IPF) maps colored with respect to the tensile direction (TD) and short transverse direction (STD) in FIG. 5. EBSD data from the gauge region are plotted as IPF maps colored with respect to the TD and STD in FIG. 6. No significant difference in grain size, shape, or orientation between the grip and gauge regions can be seen in these images.

To visualize the dislocation substructure created by the rapid cooling associated with SLM, EB SD data from the grip and gauge regions are plotted as kernel average misorientation (KAM) maps in FIG. 7. Recall from reference [47] that KAM is one of several methods to visualize the lattice curvature created by geometrically necessary dislocations. W hile not a quantitative measurement of dislocation density, KAM maps allow qualitative differences in the density of geometrically necessary dislocations to be evaluated. The KAM maps in FIG. 7(a) and (b) suggest that there are no significant differences in the density of geometrically necessary dislocations between the grip and gauge regions of this specimen. It is important to note that the chemical microsegregation visible in the optical images shown in FIG. 4 are not visible in these EBSD data and are too fine to be detected using EDS [6, 48].

### Example 4

### Electropulsing Aluminum Magnesium Silicon

A total of six AlSi10Mg samples were electropulsed for this study. The specimens and conditions under which each specimen was treated are listed in Table 2. Each AlSi10Mg specimen that was electropulsed is labelled as AlEpulse-0X, where “0X” is a unique identifier for each specimen. Specimens were numbered in order of increasing average peak current density applied to the specimen. For comparison, two additional AlSi10Mg specimens from the same build plate were characterized for this study. One specimen was in the as-received (as-printed) condition while a second specimen was annealed in air at 300° C. for two hours. These specimens will be referred to as the “as-received” and “heat-treated” samples, respectively.

TABLE 2
Conditions applied to each of the AlSi10Mg used in this study*

| | Average Peak | Average Peak | Number of |
|---|---|---|---|
| | Current Density | Sample Tem- | Pulses |
| Specimen | [kA/mm²] | perature [° C.] | Applied |
| As-received | — | — | — |
| Heat-treated | — | — | — |
| (300° C., | | | |
| 2 hours) | | | |
| AlEpulse-01 | 1.32 | 196 | 100 |
| AlEpulse-02 | 1.40 | 245 | 20 |
| AlEpulse-03 | 1.53 | 290 | 20 |
| AlEpulse-04 | 1.68 | 365 | 100 |
| AlEpulse-05 | 1.78 | 377 | 20 |
| AlEpulse-06 | 1.98 | 430 | 15 |

*One specimen was tested in the as-received (as-built) condition, and a second was
annealed in air for 2 hours at 300° C.; the six other samples were all electropulsed. For each of
these samples, the average peak current density, average peak sample temperature, and number
of pulses applied are listed.

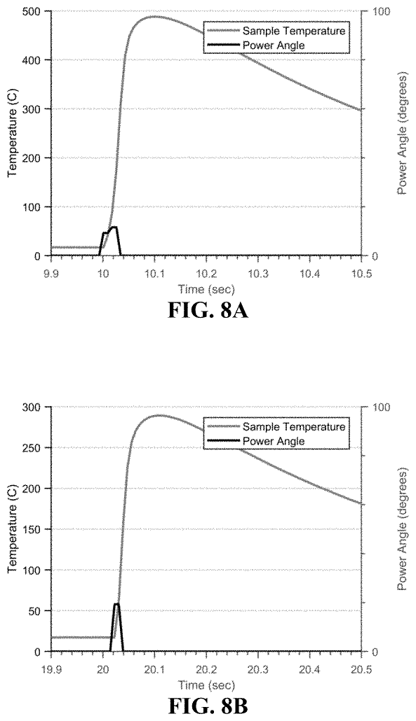

As was observed when electropulsing stainless steel samples, the controller occasionally applied two electrical pulses to AlSi10Mg samples rather than one. For example, plots of controller power angle for the first and second pulses applied to sample AlEpulse-03 are provided in FIG. 8A-8B. In the AlSi10Mg samples, a double pulse typically increased sample temperature by more than 100° C., as shown in this figure. The occurrence of these double pulses appeared to be random, occurring approximately once every 15 pulses. To avoid confusion, the average peak sample temperature reported in Table 2 is only for pulses during which a single electrical pulse was sent to the sample. Samples AlEpulse-05 and AlEpulse-06 did not receive any “double-pulse” cycles during electropulsing. As for the stainless steel samples, a single pulse lasted approximately 0.01 seconds and a double pulse lasted approximately 0.02 seconds.

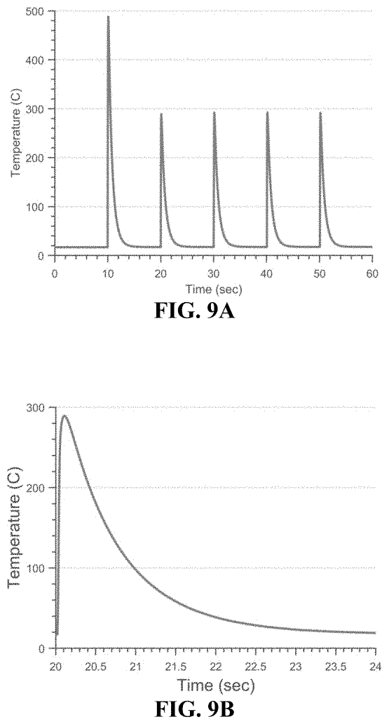

Representative temperature versus time data for the first five electropulses applied to sample AlEpulse_03 are provided in FIG. 9A. As Table 2 summarizes, the average peak sample temperature varied significantly with the applied current density. Regardless of the maximum temperature reached by the sample during pulsing, though, the specimen reached its maximum temperature within approximately 0.2 seconds of applying an electrical pulse. This can be seen in the plot provided in FIG. 9B. Regardless of the maximum specimen temperature, the specimen temperature dropped below 100° C. within 1 second of reaching the maximum temperature. Specimens returned to room temperature within approximately 2 seconds of applying an electrical pulse.

After treatment, the as-received, heat-treated, and five of the six electropulsed samples were elongated to failure in tension. Specimen AlEpulse-06 was not tested in tension. The yield and ultimate strengths and the ductility of these specimens are listed in Table 3. Tensile data from four of these specimens are plotted in FIG. 11.

TABLE 3
Mechanical properties for tested AlSi10Mg samples

| | Yield Stress | Ultimate Stress | Ductility [% |
|---|---|---|---|
| Specimen | [MPa] | [MPa] | Elongation] |
| As-received | 215 | 350 | 2.12 |
| Heat-treated | 115 | 232 | 13.76 |
| (300° C., | | | |
| 2 hours) | | | |
| AlEpulse-01, 1.32 | 167 | 341 | 3.26 |
| kA/mm² X100 | | | |
| AlEpulse-02, 1.40 | 180 | 338 | 2.33 |
| kA/mm² X20 | | | |
| AlEpulse-03, 1.53 | 173 | 316 | 2.6 |
| kA/mm² X20 | | | |
| AlEpulse-04, 1.68 | 117 | 285 | 6.09 |
| kA/mm² X100 | | | |
| AlEpulse-05, 1.78 | 163 | 304 | 4.68 |
| kA/mm² X20 | | | |

To clearly observe the effects of electropulsing on the Si distribution within an AlSi10Mg sample, specimen AlEpulse-06 was ground, polished, and etched. It was not mechanically deformed after electropulsing. An optical image of this specimen is provided in FIG. 13. T his image suggests that the distribution of Si in the gauge (electropulsed) region of specimen AlEpulse-06 was significantly different than that in the grip (untreated) region of this specimen. To observe differences in Si distribution between the gauge and grip regions of this specimen, electron channeling contrast (ECCI) images of both regions were taken and are shown in FIG. 13. Si appears as white in these images; some of the Si-rich regions are labelled in FIG. 13. These images indicate that electropulsing only affected the microstructure within the gauge region of this specimen.

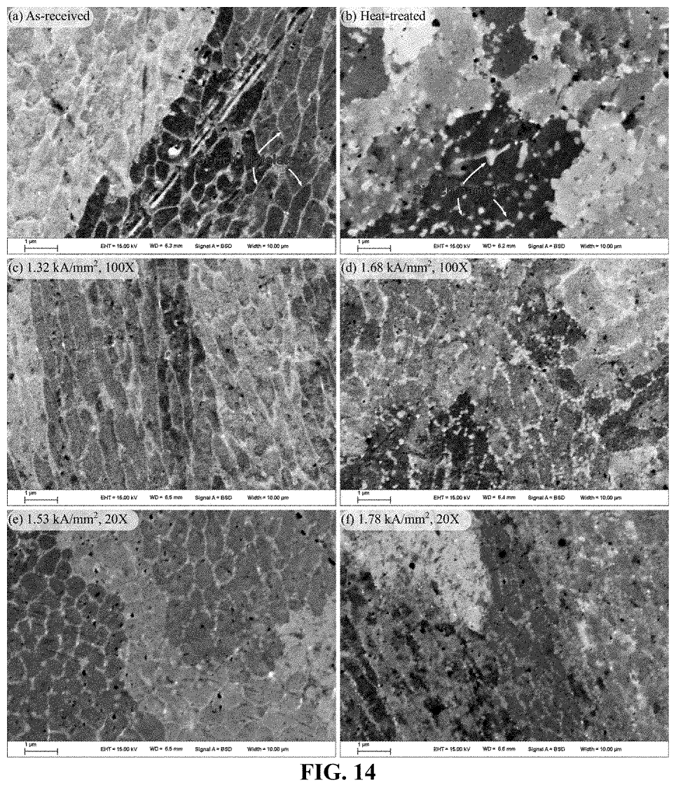

All seven of the specimens that were elongated to failure were also ground and polished after mechanical deformation. These specimens were not etched. ECCI images were taken within the gauge regions of all seven of these samples; care was taken to perform imaging away from the most-deformed region of the specimen near the fracture surface. ECCI images of the specimens are provided in FIG. 14.

After imaging, Vickers hardness values were measured within the deformed gauge region of all seven of these samples. For each specimen, care was taken to perform hardness measurements away from the most-deformed region of the gauge region near the fracture surface. Vickers hardness was also measured in the undeformed gauge region of specimen AlSi10Mg. All Vickers hardness values are reported in Table 4.

TABLE 4
Vickers hardness values for tested AlSi10Mg samples

| | Average Vickers |
|---|---|
| Specimen | Hardness (HV) |
| As-received | 127 |
| Heat-treated (300° C., 2 hours) | 77 |
| AlEpulse-01, 1.32 kA/mm² X100 | 117 |
| AlEpulse-02, 1.40 kA/mm² X20 | 131 |
| AlEpulse-03, 1.53 kA/mm² X20 | 121 |
| AlEpulse-04, 1.68 kA/mm² X100 | 97 |
| AlEpulse-05, 1.78 kA/mm² X20 | 109 |
| AlEpulse-06, 1.98 kA/mm² X15 | 101 |

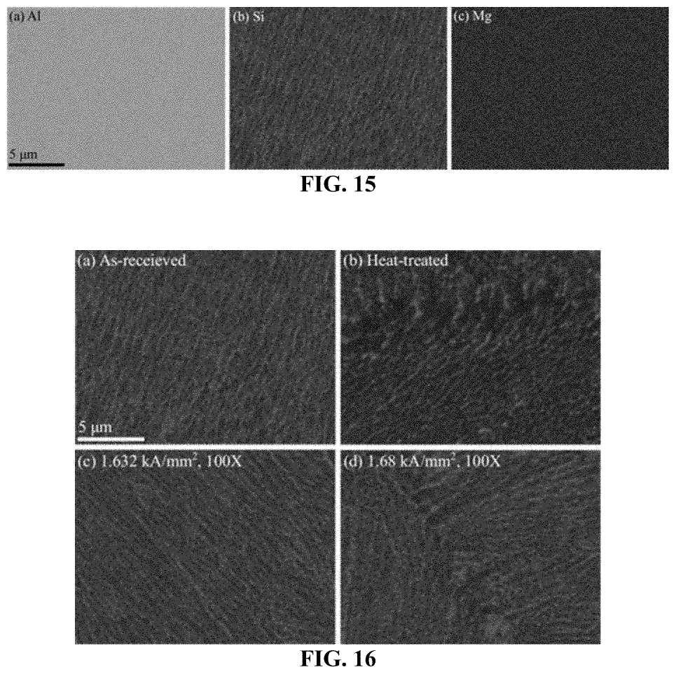

To characterize how electropulsing altered the Si in SLM AlSi10Mg samples, EDS was performed on an as-received sample and two electropulsed samples, samples AlEpulse-01 and AlEpulse-04. EDS was also performed on the heat-treated samples. For all conditions, it was observed that Al and Mg were homogeneously distributed throughout the microstructure. Representative EDS data from the as-received specimen showing the distribution of Al, Si and Mg are plotted in FIG. 15. The distribution of Si in the as-built material as a cellular structure is apparent. It is important to note that the cell spacing of Si in this sample is near the spatial resolution of EDS. EDS data indicated that the distribution of Si varied depending on the treatment conditions. EDS data showing the distribution of Si in the as-received, heat-treated, AlEpulse-01, and AlEpulse04 samples are plotted in FIG. 16.

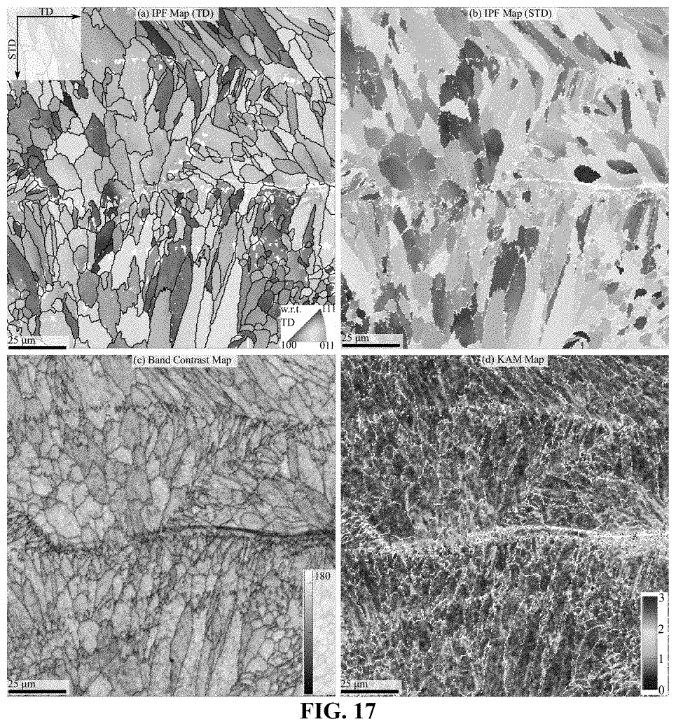

To characterize how electropulsing altered the grain and dislocation structures of SLM AlSi10Mg samples, EB SD data were collected from the as-received grip and electropulsed gauge regions of sample AlEpulse-06 using a stepsize of 0.4 μm. Recall from Table 2 that this sample was pulsed 20 times with an average peak current density of 1.98 kA/mm². Representative EBSD data from one of the datasets collected from the grip region are plotted as IPF maps colored with respect to the TD and STD, a band contrast map, and a KAM map in FIG. 17.

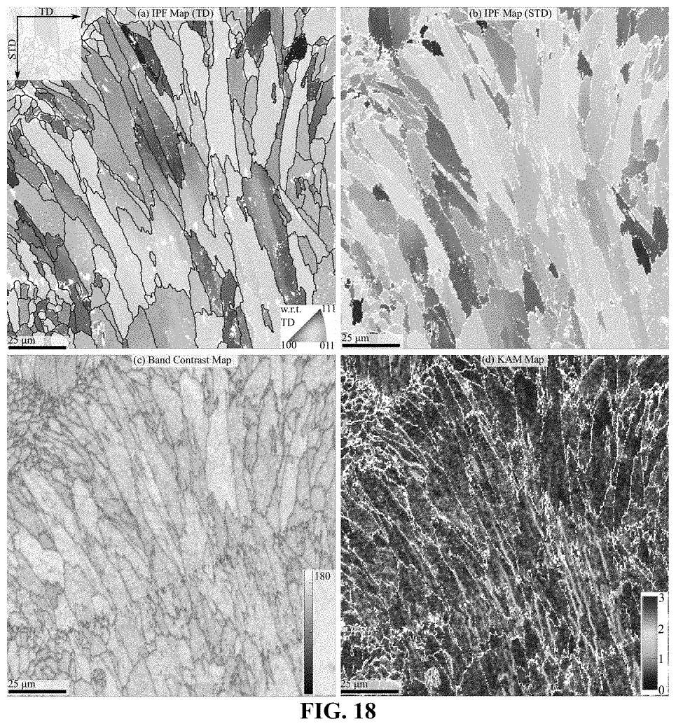

Representative EB SD data from one of the datasets collected from the gauge region are plotted as IPF maps colored with respect to the TD and STD, a band contrast map, and a KAM map in FIG. 18. While not quantitative measurements of dislocation density, the band contrast and KAM maps suggest that the dislocation density in the gauge region of this specimen is less than that in the grip region.

### Example 5

### Microstructural Evolution After Electropulsing

The present study examined if electropulsing could be used to perform microstructural modification on additively manufactured stainless steel (316 L) and aluminum alloys (AlSi10Mg). Recent studies have demonstrated that, compared to conventional wrought materials, additively manufactured metals can require significantly higher temperatures and longer exposure times to produce similar microstructural modifications. It was thus unclear if electropulsing would affect additively manufactured materials in the same way as the wrought, cast, or rolled materials examined in previous studies of electropulsing.

FIG. 4 demonstrates that electropulsing significantly reduced the microsegregation associated with SLM of stainless steels. The EB SD data presented in FIGS. 5-7 indicate that this was accomplished without significantly altering the dislocation substructure or grain structure created by the rapid cooling associated with SLM. Moreover, no significant difference Vickers hardness was measured between the grip and gauge regions of this specimen. This suggests that electropulsing can be used to remove microsegregation in SLM 316 L SS materials without significantly altering other microstructural features. Detailed analysis using transmission electron microscopy would be necessary to fully assess the chemical homogenization in this material after electropulsing [6, 48].

Susan et al. [7] demonstrated that microsegregation in SLM 316 L SS could largely be eliminated by annealing this material for 2 hours at 800° C. They noted, though, that this heat treatment reduced the Rockwell B hardness of this material from 94 to 90, which corresponds approximately to a reduction in Vickers hardness from 209 to 183. It is likely that annealing for 2 hours at 800° C. allowed at least partial recovery of the dislocation substructure created during SLM. In contrast, EB SD and hardness measurements suggest that electropulsing can remove microsegregation in SLM 316 L SS without significantly altering the dislocation structure. In their study of the mechanical properties of stainless steels fabricated using LENS, Smith et al. [48] concluded that “the mechanical properties of deposited austenitic stainless steels can be influenced by controlling thermomechanical history during the manufacturing process to alter the character of compositional microsegregation and the amount of induced plastic deformation.” The present study suggests that electropulsing may provide a tunable method to modify microsegregation in AM stainless steels without affecting dislocations and may thus provide a more controlled method of fine-tuning mechanical properties.

It is also important to note that electropulsing provides a significantly more rapid method for altering microsegregation in AM stainless steels. The study of Susan et al. [7] suggests that annealing for approximately 2 hours at 800° C. is necessary to remove microsegregation in SLM 316 L SS. In the present study, electropulsing appears to have removed, or at least significantly reduced, microsegregation after the application of only 10 electrical pulses. Each pulse lasts 0.01 seconds, though approximately 20 seconds after pulsing are required for the specimen to cool to room temperature. Even conservatively, this study suggests that, using electropulsing, only 200 seconds are needed to produce a similar level of homogenization in SLM 316 L SS to that observed by Susan et al. [7] after 2 hours at 800° C. In essence, electropulsing was at least thirty-six times faster at altering the microstructure of SLM 316 L SS than conventional thermal annealing.

As FIGS. 13-15 show, in the as-built AlSi10Mg material used in this study, the α-Al+silicon terminal interdendritic eutectic constituent was disturbed as a cellular structure. The spacing of cells was approximately 1 μm. As FIG. 14(b) and FIG. 16(b) show, annealing this material for two hours at 300° C. created spheroidized Si distributed throughout the α-Al phase. This significantly decreased the yield strength, UTS, and Vickers hardness of the AlSi10Mg material.

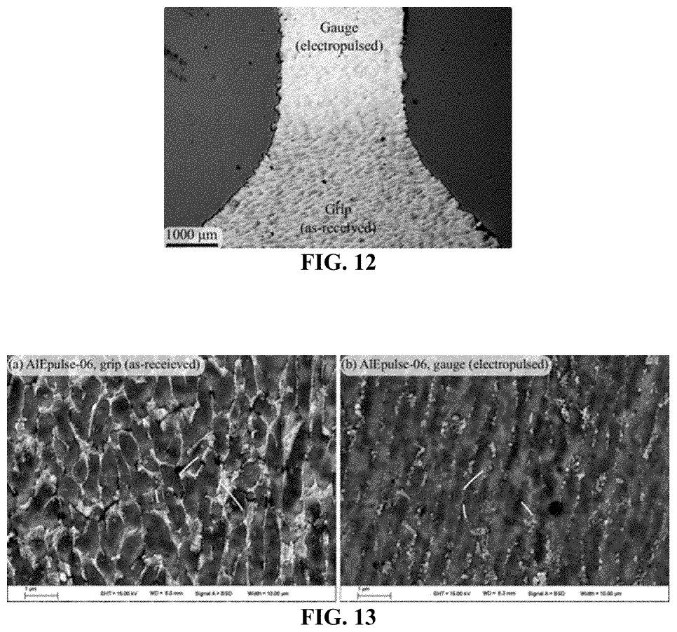

FIGS. 12-14 and 16 demonstrate that, for some combinations of current density and number of pulses, electropulsing significantly altered the distribution of the cellular, Si-rich, interdendritic constituent. In particular, the microstructures of samples AlEpulse-04 and AlEpulse-06 clearly contained partially spheroidized Si. ECCI images and EDS data suggest that, qualitatively, compared to the microstructure of the heat-treated sample, the Si-rich, terminal eutectic constituent was not as spheroidized in these electropulsed samples as in the heat-treated sample.

FIGS. 12-14 and 16 also show that relatively little spheroidization occurred in other electropulsed samples, such as AlEpulse-01. The EB SD data provided in FIGS. 17-18 suggest that electropulsing may have allowed some of the residual dislocation structure in the AlSi10Mg material to recover, though more work would be necessary to confirm this. EBSD data also indicate that grain size, shape, and orientation were not significantly affected by electropulsing.

As expected, the partial spheroidization of the Si-rich constituent produced by electropulsing resulted in increased part ductility and decreased part strength. This can be seen in FIG. 11 and Tables 3-4. No combination of current density and number of pulses examined in this study produced samples with elongation values similar to those after two hours of annealing at 300° C. However, similar mechanical properties to those observed by references [42] and [43] after the T6 heat treatment or by reference [5] after 0.25 hours of annealing at 307° C. were observed following some electropulsing treatments, notably those given to samples AlEpulse-04 and AlEpulse-06.

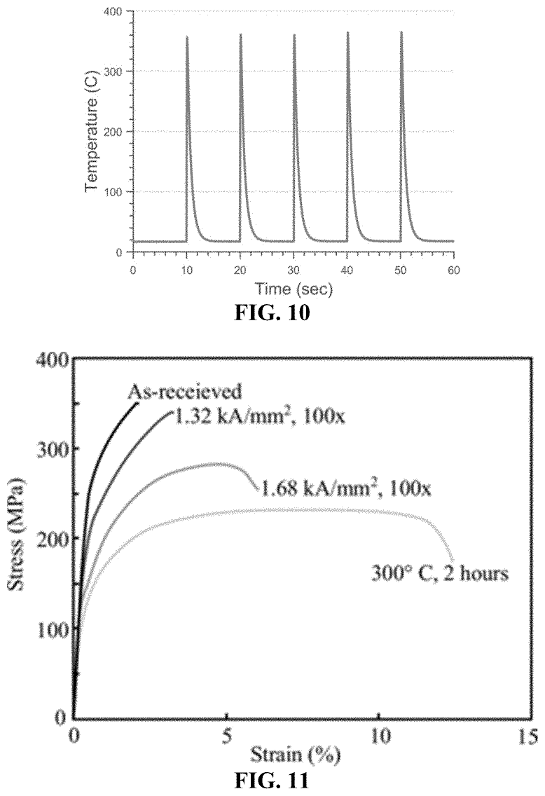

As for the SLM 316 L SS material, it appears that electropulsing may provide a much more rapid path to modifying the microstructure and mechanical properties of SLM AlSi10Mg materials than conventional thermal annealing approaches. The microhardness values of sample AlEpulse-06, which was pulsed 15 times at a current density of 1.98 kA/mm², are comparable to those reported by reference [5] after 0.25 hours of annealing at 307° C. For the AlSi10Mg material used in this study, FIGS. 9-10 show that the material cooled from its peak temperature to 100° C. within ≈1 second and reached room temperature within ≈2 seconds. While not performed for this study, these results suggest that comparable mechanical properties to those observed after annealing at 307° C. for 0.25 hours can be produced by ≈30 seconds of electropulsing at a current density of ≈2 kA/mm². Further study will be necessary to determine if larger current densities or increased number of pulses can attain ductilities of ≈15%.

Perhaps the most surprising finding of this study was the extent to which microstructural modifications produced by electropulsing depended on the number of pulses applied and the current density. For SLM 316 L SS, optical images suggested that 5 pulses did not significantly affect microsegregation; however, 10 pulses appears to significantly reduce microsegregation compared to the as-built 316 L SS. For the AlSi10Mg material, it was observed that microstructural changes produced by electropulsing were highly sensitive to the current density applied to the sample. As Table 3 summarizes, a 15% increase in current density from 1.53 to 1.78 kA/mm² nearly doubled the ductility of the material. Conversely, an increase from 1.40 to 1.53 kA/mm² did not significantly alter the ductility of the material. In addition, as FIG. 4, 12 show, microstructural changes from electropulsing were restricted to the gauge region of the specimen where the current density was the largest.

Overall, microstructural changes due to electropulsing appear to be restricted to areas of the microstructure where the resistance is lowest. In the present study, this corresponds to the thinnest areas of the specimen. In addition, to obtain a desired microstructure using electropulsing, both current density and number of pulses applied to the sample can be varied to reach a desired microstructure. Further mechanistic studies may elucidate what combination of current density and number of pulses could be selected to obtain a desired microstructure. It is hoped that this study motivates future investigation of the mechanisms of electropulsing so that this technique can be applied to future postprocessing needs.

Accordingly, the present study demonstrated that electropulsing can be used to rapidly modify the microstructures of two representative SLM materials: 316 L SS and AlSi10Mg. In particular, we observed that electropulsing reduced microsegregation in 316 L SS without significantly altering the dislocation and grain structures created by the SLM processes. We also observed electropulsing partially spheroidized the cellular, Si-rich, eutectic constituent created by rapid solidification during SLM. This increased the ductility and decreased the strength of electropulsed AlSi10Mg samples.

For both materials, these microstructural modifications were produced at least an order of magnitude faster via electropulsing than via conventional thermal annealing. It was also observed that the microstructural changes by electropulsing were highly sensitive to the applied current density and the number of electrical pulses. These results indicate that electropulsing may provide a much more rapid and controllable method for modifying the microstructures of SLM materials than conventional annealing approaches. Indeed, it may be possible to specifically tune the properties of an entire structure by careful part design and subsequent electropulsing.

### REFERENCES

1. Trelewicz J R et al., JOM 2016; 68:850-859.

2. Takata N et al., Mater. Sci. Eng. A 2017; 704:218-228.

3. Uzan N E et al., Mater. Sci. Eng. A 2017; 704:229-237.

4. Finfrock C B et al., Metallograph. Microstruct. Anal. 2018; 7:443-456.

5. Yang Pet al., J. Mater. Res. 2018;33:1701-1712.

6. Smith T R et al., JOM 2018; 70:358-363.

7. Susan D et al., Sandia Report NO. SAND2018-8953C, 2018, 21 pp.

8. Conrad H et al., Mater. Sci. Eng. A 2000; 287:227-237.

9. Troitskii O A, Strength Mater. 1976; 8:1466-1471.

10. Troitskii O A, ZhETF Pisma Redaktsiiu 1969; 10, p. 18.

11. Xiao S H et al., Scripta Mater. 2002; 46:1-6.

12. Hu G et al., Metallurg. Mater. Trans. A 2011; 42, p. 3484.

13. Qin R S et al., J. Mater. Sci. 2011; 46:2838-2842.

14. Xu X et al., Mater. Sci. Eng. A 2014; 612:223-226.

15. To S et al., Mater. Trans. 2009; 50:1105-1112.

16. Song H et al., Mater. Sci. Eng. A 2008; 490:1-6.

17. Jiang Y et al., J. Alloys Compounds 2011; 509:4308-4313.

18. Hao T et al., Maters. Trans. 2005; 46:2898-2907.

19. Takemoto R et al., Acta Metallurg. Mater. 1995; 43:1495-1504.

20. Zhou Y et al., J Mater. Res. 2002; 17:3012-3014.

21. To S et al., Mater. Trans. 2010:1010041185.

22. Yizhou Z et al., J Mater. Res. 2001; 16:17-19.

23. Wang X L et al., Appl. Phys. Lett. 2006; 89:061910.

24. Rahnama A et al., Scripta Mater. 2015; 96:17-20.

25. Zhou Y et al., J Mater. Res. 2002; 17:921-924.

26. Lu W J et al., Mater. Sci. Technol. 2015; 31:1530-1535.

27. Park J W et al., Mater. Characterization 2017; 133:70-76.

28. Huang K et al., Mater. Characterization 2017; 129:121-126.

29. Conrad H et al., Scripta Metallurg. 1983: 17:411-416.

30. Sorbello R S, Phys. Rev. B 1985; 31:798.

31. Black J R, IEEE Trans. Electron Devices 1969; 16: 338-347.

32. Xu Q et al., Mater. Lett. 2010; 64:1085-1087.

33. Zhang D et al., Metallurg. Mater. Trans. A 2012; 43:1341-1346.

34. Teng G Q et al., J. Mater. Sci. Lett. 1995; 14:144-145.

35. Lippold J C & Kotecki D J, In Welding Metallurgy and Weldability of Stainless Steels, 2005, p. 376.

36. Elmer J W et al., Metallurg. Trans. A 1989; 20:2117-2131.

37. Montero-Sistiaga M L et al., Additive Manufact. 2018; 23:402-410.

38. Yasa E et al., Proc. Eng. 2011; 19:389-395.

39. Zhong Y et al., J. Nucl. Mater. 2016; 470:170-178.

40. Brooks J A et al., Metallurg. Trans. A 1983; 14:23-31.

41. Read R et al., Mater. Design. 2015; 65:417-424.

42. Aboulkhair N T et al., Mater. Sci. Eng. A 2016; 667:139-146.

43. Tradowsky U et al., Mater. Design. 2016; 105:212-222.

44. Vander Voort G F, Metallography, principles and practice (ASM International), 1999.

45. Bachmann F, Hielscher R & Schaeben H, In Solid State Phenomena, 2010, pp. 63-68.

46. Gorsse S et al., Sci. Technol. Adv. Mater. 2017; 18: 584-610.

47. Wright S I et al., Microscopy Microanal. 2011; 17:316-329.

48. Smith T R et al., Acta Materialia 2019; 164:728-740.

### Other Embodiments

All publications, patents, and patent applications mentioned in this specification are incorporated herein by reference to the same extent as if each independent publication or patent application was specifically and individually indicated to be incorporated by reference.

While the invention has been described in connection with specific embodiments thereof, it will be understood that it is capable of further modifications and this application is intended to cover any variations, uses, or adaptations of the invention following, in general, the principles of the invention and including such departures from the present disclosure that come within known or customary practice within the art to which the invention pertains and may be applied to the essential features hereinbefore set forth, and follows in the scope of the claims.

Other embodiments are within the claims.

1. A method comprising:
providing a test sample comprising an additively manufactured material; and
delivering an electrical pulse to the test sample, thereby providing a treated material having reduced microsegregration of one or more elements, as compared to the test sample.

2. The method of claim 1, wherein the test sample comprises aluminum and/or iron.

3. The method of claim 1, wherein the electrical pulse increases a temperature of the test sample to from about 300° C. to about 1000° C.

4. The method of claim 1, wherein the delivering step comprises delivering a plurality of electrical pulses.

5. The method of claim 4, wherein the plurality of electrical pulses is repeated every 1 second to about 20 seconds.

6. The method of claim 4, wherein the plurality of pulses is of from about 5 to about 200 pulses.

7. The method of claim 6, wherein the plurality of pulses is of from about 5 to about 20 pulses.

8. The method of claim 1, wherein the electrical pulse comprises an alternating current.

9. The method of claim 8, wherein the alternating current has a frequency of from about 20 Hz to about 100 Hz

10. The method of claim 8, wherein a duration of the electrical pulse is of from about 5 ms to about 30 ms.

11. The method of claim 1, wherein the electrical pulse comprises a direct current.

12. The method of claim 11, wherein a duration of the electrical pulse is of from about 50 ms to about 5 s.

13. The method of claim 1, wherein the electrical pulse provides a current density of from about 0.1 kA/mm² to about 5 kA/mm².

14. The method of claim 1, wherein the electrical pulse provides a maximum current of from about 5 kA to about 20 kA.

15. A method comprising:
providing a test sample comprising an additively manufactured material; and
delivering a plurality of electrical pulses to the test sample, thereby providing a treated material having reduced microsegregration of one or more elements, as compared to the test sample.

16. The method of claim 15, wherein a duration of the plurality of electrical pulses is of from about 100 seconds to about 1000 seconds.

17. The method of claim 15, wherein the plurality of electrical pulses is repeated every 1 second to about 20 seconds and/or wherein the plurality of pulses is of from about 5 to about 200 pulses.

18. The method of claim 15, wherein the electrical pulse comprises an alternating current.

19. The method of claim 15, wherein a duration of the electrical pulse is of from about 5 ms to about 30 ms.

20. The method of claim 1, wherein the electrical pulse provides a current density of from about 0.1 kA/mm² to about 5 kA/mm².
